(19) United States
(12) Patent Application Publication
(10) Pub. No.: US 2017/0158927 A1
(43) Pub. Date: Jun. 8, 2017

(54) One-Component Moisture-Curable Urethane Composition and Method for Producing Same

(71) Applicant: The Yokohama Rubber Co., LTD., Minato-ku, Tokyo (JP)

(72) Inventor: Kiminori Araki, Hiratsuka-shi, Kanagawa (JP)

(73) Assignee: The Yokohama Rubber Co., Ltd., Hiratsuka-shi, Kanagawa (JP)

(21) Appl. No.: 15/325,699

(22) PCT Filed: Jun. 30, 2015
(86) PCT No.: PCT/JP2015/068865

§ 371 Date: Jan. 11, 2017

(30) Foreign Application Priority Data
Jul. 11, 2014 (JP) 2014-143313

(51) Int. Cl. C09J 175/04; C08L 83/00

(52) U.S. Cl. CPC C09J 175/04; C08L 83/00

(57) ABSTRACT

The present technology is to provide a one-part moisture-curable polyurethane composition having excellent adhesion to an adherend (coated plate), and a method for producing such a composition. The present technology is a one-part moisture-curable urethane composition including a preliminary composition obtained by mixing a urethane prepolymer, an aliphatic isocyanate A, and an aminosilane compound B, and a catalyst; and a method for producing such a composition.

### TECHNICAL FIELD

The present technology relates to a one-part moisture-curable urethane composition and a method for producing such a composition.

### BACKGROUND ART

Various urethane resin compositions have been widely used as sealing agents, adhesive agents, and the like.

As such urethane resin compositions, use of one-part moisture-curable polyurethane composition, which cures by moisture in the air or the like, has been increasing recently from the perspective of ease in handling that does not require mixing and/or adjusting the composition on site when the composition is used, or the like.

For example, Japanese Unexamined Patent Application Publication No. 2000-128949A describes “a one-part moisture-curable polyurethane composition including: (A) a urethane prepolymer, and (B) a silane compound containing an average of at least 1.5 NCO groups and an average of at least 1.5 hydrolyzable alkoxy groups in each molecule, the silane compound containing at least one type selected from the group consisting of (B-1) a silane compound obtained by an addition reaction of a polyisocyanate compound having at least 3 NCO groups in each molecule and a secondary aminoalkoxysilane, wherein the polyisocyanate compound is a reaction product obtained by reacting a polyol that is a triol or higher polyol and that has a molecular weight of 500 or less with diisocyanate and (B-2) a silane compound that has a lysine backbone and that is obtained by an addition reaction of a lysine isocyanate having 2 or 3 isocyanate groups with a secondary aminoalkoxysilane” (Japanese Unexamined Patent Application Publication No. 2000-128949A).

However, it was found that, depending on the type of an adherend (coated plate), conventionally known one-part moisture-curable polyurethane compositions described in Japanese Unexamined Patent Application Publication No. 2000-128949A or the like may exhibit poor adhesion.

### SUMMARY

The present technology provides a one-part moisture-curable polyurethane composition which exhibits excellent adhesion to an adherend (coated plate).

The inventor of the present technology has found that excellent adhesion to an adherend (coated plate) is achieved by allowing a preliminary composition obtained by mixing a urethane prepolymer, an aliphatic isocyanate A, and an aminosilane compound B, and a catalyst to be contained, and thus completed the present technology.

Specifically, the inventor discovered a one-part moisture-curable urethane composition having the following features.

1. A one-part moisture-curable urethane composition including:

a preliminary composition obtained by mixing a urethane prepolymer, an aliphatic isocyanate A, and an aminosilane compound B, and

a catalyst.

2. The one-part moisture-curable urethane composition according to 1 above, where the urethane prepolymer is obtained by reacting polypropylene glycol with diphenylmethane diisocyanate.

3. The one-part moisture-curable urethane composition according to 1 or 2 above, where the aliphatic isocyanate A is at least one type of aliphatic isocyanate-modified product a selected from the group consisting of reaction products of a polyol having tri- or higher functionality and an aliphatic polyisocyanate, allophanates of aliphatic polyisocyanate, nurates of aliphatic polyisocyanate, and biurets of aliphatic polyisocyanate.

4. The one-part moisture-curable urethane composition according to any one of 1 to 3 above, where the aminosilane compound B contains, in each molecule, an alkoxysilyl group and a nitrogen atom to which an aromatic ring and a hydrogen atom are bonded.

5. The one-part moisture-curable urethane composition according to 4 above, where the alkoxysilyl group is a methoxysilyl group or an ethoxysilyl group.

6. The one-part moisture-curable urethane composition according to any one of 1 to 5 above, where, per 100 parts by weight of the urethane prepolymer,

an amount of the aliphatic isocyanate A is from 0.8 to 10 parts by mass, and

an amount of the aminosilane compound B is from 0.1 to 4 parts by mass.

7. The one-part moisture-curable urethane composition according to any one of 1 to 6 above, where the catalyst contains at least one type selected from the group consisting of products formed by reacting 1,3-diacetoxy-1,1,3,3-tetrabutyl-distannoxane with ethyl silicate in a molar ratio of 1:0.8 to 1.2, dibutyltin acetylacetate, dimorpholinodiethyl ether, and diamino ethylmorpholine.

8. The one-part moisture-curable urethane composition according to any one of 1 to 7 above, where the catalyst contains, as an organotin catalyst, at least one selected from the group consisting of products formed by reacting 1,3-diacetoxy-1,1,3,3-tetrabutyl-distannoxane with ethyl silicate in a molar ratio of 1:0.8 to 1.2 and dibutyltin acetylacetate,

dimorpholinodiethyl ether, and

diamino ethylmorpholine.

9. The one-part moisture-curable urethane composition according to 8 above, where an amount of the organotin catalyst is from 0.0005 to 0.3 parts by mass per 100 parts by mass of the urethane prepolymer.

10. The one-part moisture-curable urethane composition according to 8 or 9 above, where an amount of the dimorpholinodiethyl ether is from 0.004 to 1.2 parts by mass per 100 parts by mass of the urethane prepolymer.

11. The one-part moisture-curable urethane composition according to any one of 8 to 10 above, where an amount of the diamino ethylmorpholine is 1 part by mass or less per 100 parts by mass of the urethane prepolymer.

12. The one-part moisture-curable urethane composition according to any one of 1 to 11 above, where the preliminary composition further contains a filler.

13. The one-part moisture-curable urethane composition according to 12 above, where the filler is at least one selected from the group consisting of carbon blacks and white fillers.

14. The one-part moisture-curable urethane composition according to any one of 1 to 13 above, where the preliminary composition further contains a plasticizer.

15. A method for producing a one-part moisture-curable urethane composition, the method comprising:

a mixing step 1 of obtaining a preliminary composition by mixing a urethane prepolymer, an aliphatic isocyanate A, and an aminosilane compound B; and

a mixing step 2 of producing the one-part moisture-curable urethane composition described in any one of 1 to 14 above by mixing the preliminary composition and a catalyst.

16. The method for producing a one-part moisture-curable urethane composition according to 15 above, where at least one selected from the group consisting of fillers and plasticizers is further used in the mixing step 1.

### Advantageous Effects of Technology

The one-part moisture-curable urethane composition of the present technology exhibits excellent adhesion to an adherend (coated plate).

According to the production method of the present technology, a one-part moisture-curable urethane composition exhibiting excellent adhesion to an adherend (coated plate) can be produced.

### DETAILED DESCRIPTION

The present technology is described in detail below.

The one-part moisture-curable urethane composition of the present technology (composition of the present technology) is

a one-part moisture-curable urethane composition including:

a preliminary composition obtained by mixing a urethane prepolymer, an aliphatic isocyanate A, and an aminosilane compound B, and

a catalyst.

The composition of the present technology exhibits excellent adhesion to an adherend (coated plate) by allowing a preliminary composition obtained by mixing a urethane prepolymer, an aliphatic isocyanate A, and an aminosilane compound B to be contained. Note that, in the present specification, the condition where adhesion to an adherend (coated plate) is excellent may be simply referred to as “excellent adhesion”.

In the present technology, the preliminary composition is produced by mixing a urethane prepolymer, an aliphatic isocyanate A, and an aminosilane compound B. In the preliminary composition, the urethane prepolymer and the aminosilane compound B may be reacted. Furthermore, the aliphatic isocyanate A and the aminosilane compound B may be reacted. Therefore, the preliminary composition may further contain a reaction product formed by reacting the aminosilane compound B with the aliphatic isocyanate A, and/or a reaction product formed by reacting the aminosilane compound B with the urethane prepolymer, after the mixing.

The urethane prepolymer will be described below. The urethane prepolymer used in the composition of the present technology is not particularly limited as long as the urethane prepolymer is a urethane prepolymer having an isocyanate group at a terminal. For example, a substance obtained by reacting polyisocyanate with a compound having two or more active hydrogen-containing groups in each molecule (active hydrogen compounds) in a manner that the amount of the isocyanate groups contained in the polyisocyanate is in excess relative to the amount of the active hydrogen-containing groups contained in the active hydrogen compound can be used. The urethane prepolymer may contain from 0.5 to 5 mass % of isocyanate group at molecular terminals.

The polyisocyanate used during production of the urethane prepolymer is not particularly limited as long as the polyisocyanate has two or more isocyanate groups in each molecule.

Examples of the polyisocyanate include aromatic polyisocyanates, such as tolylene diisocyanate (TDI), diphenylmethane diisocyanate (MDI; e.g. 4,4′-diphenylmethane diisocyanate and 2,4′-diphenylmethane diisocyanate), 1,4-phenylene diisocyanate, polymethylene polyphenylene polyisocyanate, xylylene diisocyanate (XDI), tetramethylxylylene diisocyanate (TMXDI), tolidine diisocyanate (TODI), 1,5-naphthalene diisocyanate (NDI), and triphenylmethane triisocyanate; aliphatic and/or alicyclic polyisocyanates, such as hexamethylene diisocyanate (HDI), trimethylhexamethylene diisocyanate (TMHDI), lysine diisocyanate, and norbornane diisocyanate (NBDI), transcyclohexane-1,4-diisocyanate, isophorone diisocyanate (IPDI), bis(isocyanate methyl)cyclohexane (H₆XDI), and dicyclohexylmethane diisocyanate (H₁₂MDI); carbodiimide-modified polyisocyanates of these; and isocyanurate-modified polyisocyanates of these.

A single polyisocyanate can be used or a combination of two or more polyisocyanates can be used.

Among these, an aromatic polyisocyanate is preferable, and MDI is more preferable, from the perspective of excellent curability.

The compound having two or more active hydrogen-containing groups in each molecule (active hydrogen compound) that is used during production of the urethane prepolymer is not particularly limited. Examples of the active hydrogen-containing group include a hydroxy (OH) group, amino group, and imino group.

Preferred examples of the active hydrogen compound include polyol compounds having two or more hydroxy (OH) groups in each molecule, and the like. Among these, a polyol compound is preferable.

The polyol compound is not particularly limited as long as the polyol compound is a compound having two or more hydroxy groups. Examples thereof include polyether polyols; polyester polyols; polymer polyols having a carbon-carbon bond in a main chain backbone, such as acrylic polyols, polybutadiene diols, and hydrogenated polybutadiene polyols; low molecular weight polyhydric alcohols; and mixed polyols of these. Among these, a polyether polyol is exemplified as an example of preferable aspects.

The polyether polyol is not particularly limited as long as the polyether polyol is a compound having a polyether as a main chain and having two or more hydroxy groups. The term “polyether” is a group having two or more ether bonds, and specific examples thereof include a group having a total of two or more of structural units: —R^{a}—O—R^{b}—. Note that, in the structural unit, R^{a} and R^{b} each independently represent a hydrocarbon group. The hydrocarbon group is not particularly limited. Examples thereof include a straight-chain alkylene group having from 1 to 10 carbons.

Examples of the polyether polyol include a polyoxyethylene diol (polyethylene glycol), polyoxypropylene diol (polypropylene glycol; PPG), polyoxypropylene triol, ethylene oxide/propylene oxide copolymer, polytetramethylene ether glycol (PTMEG), polytetraethylene glycol, sorbitol polyol, and the like.

The polyether polyol is preferably polypropylene glycol or polyoxypropylene triol from the perspective of excellent miscibility with polyisocyanate.

The weight average molecular weight of the polyether polyol is preferably from 500 to 20,000 because the viscosity of the urethane prepolymer, which is obtained by a reaction with isocyanate, exhibits an appropriate fluidity at the ambient temperature. In the present technology, the weight average molecular weight is a value obtained by GPC analysis (solvent: tetrahydrofuran (THF)) based on calibration with polystyrene.

The active hydrogen compound may be used alone, or a combination of two or more types of the active hydrogen compounds may be used.

The urethane prepolymer is preferably a urethane prepolymer formed by reacting a polyether polyol and an aromatic polyisocyanate, from the perspective of achieving even better adhesion and excellent curability. The urethane prepolymer is more preferably a urethane prepolymer obtained by reacting polypropylene glycol and/or polyoxypropylene triol and diphenylmethane diisocyanate.

The urethane prepolymer may be used alone, or a combination of two or more types of the urethane prepolymers may be used.

The method of producing the urethane prepolymer is not particularly limited. For example, the urethane prepolymer can be produced by using polyisocyanate in a manner that from 1.5 to 2.5 mol of isocyanate group is reacted per 1 mol of the active hydrogen-containing group (e.g. hydroxy group) contained in the active hydrogen compound, and mixing these to perform a reaction.

Note that the urethane prepolymer may contain at least one type selected from the group consisting of unreacted polyisocyanates and unreacted active hydrogen compounds.

The aliphatic isocyanate A will be described below. The aliphatic isocyanate A used in the composition of the present technology is not particularly limited as long as the aliphatic isocyanate A is an aliphatic hydrocarbon compound having at least one isocyanate group in each molecule.

The aliphatic hydrocarbon group contained in the aliphatic isocyanate A is not particularly limited. The aliphatic hydrocarbon group may be a straight-chain, branched-chain, or cyclic aliphatic hydrocarbon group, and a straight-chain aliphatic hydrocarbon group is preferable. The aliphatic hydrocarbon group may be a saturated or unsaturated aliphatic hydrocarbon group, and a saturated aliphatic hydrocarbon group is preferable.

The number of the isocyanate group contained in each molecule of the aliphatic isocyanate A is preferably 2 or more, and more preferably 2 or 3, from the perspective of even better adhesion.

Examples of the aliphatic isocyanate A include aliphatic polyisocyanates (including alicyclic polyisocyanate but not including modified products), such as hexamethylene diisocyanate (HDI), trimethyl hexamethylene diisocyanate (TMHDI), lysine diisocyanate, norbornane diisocyanate (NBDI), trans-cyclohexane-1,4-diisocyanate, isophorone diisocyanate (IPDI), bis(isocyanatemethyl)cyclohexane (H₆XDI), and dicyclohexylmethane diisocyanate (H₁₂MDI) (hereinafter, the aliphatic polyisocyanate described above may be referred to as “aliphatic polyisocyanate b”); and modified products of aliphatic polyisocyanates.

The aliphatic isocyanate A is preferably a modified product of aliphatic polyisocyanate from the perspective of even better adhesion and a wider range of adhesion depending on the environment at the time of curing.

The modified product of the aliphatic polyisocyanate is preferably at least one type of aliphatic isocyanate-modified product a selected from the group consisting of reaction products of a polyol having tri- or higher functionality and an aliphatic polyisocyanate, allophanates of aliphatic polyisocyanate, nurates of aliphatic polyisocyanate, and biurets of aliphatic polyisocyanate, from the perspective of excellent balance between adhesion and physical properties of the adhesive agent after the curing.

The aliphatic polyisocyanate used in the aliphatic isocyanate-modified product a is not particularly limited as long as the aliphatic polyisocyanate is an aliphatic hydrocarbon compound having at least two isocyanate groups in each molecule. Examples include the same as those exemplified for the aliphatic polyisocyanate b. Among these, a straight-chain aliphatic polyisocyanate is preferable, and HDI is more preferable, from the perspectives of achieving even better adhesion and being less likely to cause foaming due to the added amount.

Examples of the reaction product of a polyol having tri- or higher functionality and an aliphatic polyisocyanate include trimethylolpropane (TMP), and reaction products of trifunctional polyol, such as glycerin, and an aliphatic polyisocyanate b. Specific examples of reaction products of TMP and HDI (e.g. compound represented by Formula (5) below) and reaction products of glycerin and HDI (e.g. compound represented by Formula (6) below).

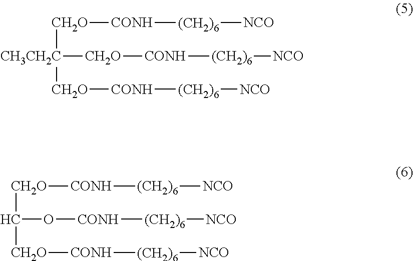

Examples of the allophanate of aliphatic polyisocyanate include an allophanate of HDI. The compound having one hydroxy group in each molecule used to form the allophanate is not particularly limited. An example thereof is pentamethylene diisocyanate.

Examples of the biuret of aliphatic polyisocyanate include a biuret of HDI. Specifically, preferred examples include a compound represented by Formula (7) below.

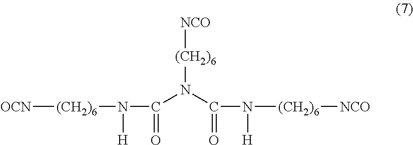

Examples of the nurate (isocyanurate) of aliphatic polyisocyanate include a nurate (isocyanurate) of HDI. Specific examples include a compound represented by Formula (8) below.

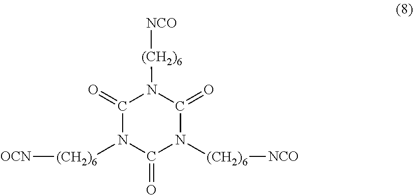

The production of the aliphatic isocyanate A is not particularly limited. Examples thereof include conventionally known aliphatic isocyanates. The aliphatic isocyanate A may be used alone, or a combination of two or more types of the aliphatic isocyanates A may be used.

The amount of the aliphatic isocyanate A is preferably from 0.8 to 15 parts by mass, more preferably from 0.8 to 10 parts by mass, and even more preferably from 1 to 5 parts by mass, per 100 parts by weight of the urethane prepolymer from the perspectives of even better adhesion, and excellent high-temperature/high-humidity adhesion and excellent breaking elongation.

The aminosilane compound B will be described below. The aminosilane compound B used in the composition of the present technology is not particularly limited as long as the aminosilane compound B is a compound having an amino group (—NH₂) and/or an imino group (—NH—) and a hydrolyzable silyl group. The amino group, the imino group, and the hydrolyzable silyl group can be bonded to each other through organic group(s).

When the aminosilane compound B contains an imino group, an example of a preferable aspect is one in which the group bonded to the imino group is an aromatic hydrocarbon group.

The aromatic hydrocarbon group is not particularly limited as long as the aromatic hydrocarbon group is a hydrocarbon group having at least one aromatic ring.

Examples of the aromatic ring include a benzene ring and a naphthalene ring.

The aromatic ring may have a substituent. Examples of the substituent include alkyl groups.

Examples of the hydrolyzable silyl group include substances in which at least one hydrolyzable group is bonded to one silicon atom. When one or two hydrolyzable groups are bonded to one silicon atom, other groups that can bond to the same silicon atom are not particularly limited. Examples thereof include hydrocarbon groups.

Examples of the hydrolyzable silyl group include alkoxysilyl groups. Specific examples thereof include methoxysilyl groups (monomethoxysilyl group, dimethoxysilyl group, and trimethoxysilyl group) and ethoxysilyl groups (monoethoxysilyl group, diethoxysilyl group, and triethoxysilyl group).

The organic group is not particularly limited. Examples thereof include hydrocarbon groups that may have a hetero atom such as an oxygen atom, nitrogen atom, and sulfur atom. Examples of the hydrocarbon group include aliphatic hydrocarbon groups (which may be in a form of straight-chain or branched-chain, and may have an unsaturated bond), alicyclic hydrocarbon groups (which may have an unsaturated bond), aromatic hydrocarbon groups, and a combination of these. At least one of the carbon atom or the hydrogen atom contained in the hydrocarbon group may be substituted with a substituent. Among these, an example of a preferable aspect is an aliphatic hydrocarbon group.

The aminosilane compound B is preferably a compound having an alkoxysilyl group and an imide group in each molecule, and more preferably a compound having an alkoxysilyl group and a nitrogen atom, to which an aromatic ring and a hydrogen atom are bonded, in each molecule from the perspectives of even better adhesion and excellent storage stability of adhesive agent.

Examples of the aminosilane compound B include compounds represented by Formula (I) below.

R¹ₙ—NH₂₋ₙ—,—R²—Si—R³₃ (I)

In Formula (I), R¹ represents an aromatic hydrocarbon group, n is 0 or 1, R² represents a divalent aliphatic hydrocarbon group, at least one of the three R³ moieties is an alkoxy group and the three R³ moieties may be the same or different. When one or two of the three R³ moieties are alkoxy group(s), the other R³ is preferably alkyl group(s).

Examples of the aromatic hydrocarbon group include a phenyl group.

Examples of the divalent aliphatic hydrocarbon group include a methylene group, an ethylene group, and a propylene group.

Examples of the alkoxy group include a methoxy group and an ethoxy group.

Examples of the alkyl group include a methyl group and an ethyl group.

Specific examples of the aminosilane compound B include N-phenyl-3-aminopropyltrimethoxysilane and N-phenyl-3-aminopropyltriethoxysilane.

The production of the aminosilane compound B is not particularly limited. Examples thereof include conventionally known methods. The aminosilane compound B may be used alone, or a combination of two or more types of the aminosilane compounds B may be used.

The amount of the aminosilane compound B is preferably from 0.1 to 10 parts by mass, more preferably from 0.1 to 4 parts by mass, and even more preferably from 0.5 to 2 parts by mass, per 100 parts by weight of the urethane prepolymer from the perspectives of even better adhesion, and excellent flow resistance and excellent breaking elongation.

In the present technology, the preliminary composition may further contain a filler. In this case, excellent deep curability after the adhesive agent is applied is achieved.

The filler is not particularly limited. An example of a preferable aspect is one in which the filler is a carbon black and/or a white filler. The filler may be, for example, a filler which has undergone surface treatment by a surface treating agent, such as fatty acids, resin acids, urethane compounds, and fatty acid esters.

The carbon black is not particularly limited. Examples thereof include conventionally known carbon blacks.

The amount of the carbon black is preferably from 30 to 150 parts by mass, and more preferably from 50 to 120 parts by mass, per 100 parts by mass of the urethane prepolymer from the perspectives of excellent flow resistance, discharging properties, and physical properties after the adhesive agent is cured.

Examples of the white filler include calcium carbonate, such as heavy calcium carbonate, precipitated calcium carbonate (light calcium carbonate), and colloidal calcium carbonate; magnesium carbonate and zinc carbonate; silica, such as fumed silica, calcined silica, precipitated silica, pulverized silica, and molten silica; diatomaceous earth; iron oxide, zinc oxide, titanium oxide, barium oxide, magnesium oxide; pyrophyllite clay, kaolin clay, and calcined clay.

The amount of the white filler is preferably from 10 to 80 parts by mass, and more preferably from 20 to 50 parts by mass, per 100 parts by mass of the urethane prepolymer from the perspectives of excellent deep curability and excellent adjustability in specific gravity.

In the present technology, the preliminary composition may further contain a plasticizer. In this case, excellent control in viscosity and physical properties and excellent coatability can be achieved.

Examples of the plasticizer include diisononyl phthalate (DINP); dioctyl adipate and isodecyl succinate; diethylene glycol dibenzoate and pentaerythritol esters; butyl oleate and methyl acetyl ricinoleate; tricresyl phosphate and trioctyl phosphate; propylene glycol adipate polyesters and butylene glycol adipate polyesters; and the like.

The plasticizer may be used alone, or a combination of two or more types of the plasticizers may be used.

The amount of the plasticizer is preferably from 10 to 100 parts by mass, and more preferably from 30 to 80 parts by mass, per 100 parts by mass of the urethane prepolymer from the perspectives of excellent control in viscosity and physical properties, and excellent coatability.

The catalyst will be described below. The catalyst used in the composition of the present technology is not particularly limited as long as the catalyst is a catalyst contributing to curing of the composition. Furthermore, from the perspectives of achieving even better adhesion to an adherend (coated plate) and being capable of adhering to an adherend without using a primer especially at low temperatures, an example of a preferable aspect is one in which the catalyst having a function that can contribute to adhesion is used.

Examples of the catalyst that can contribute to curing of the composition include amine catalysts and organotin catalysts.

An example of a preferable aspect is one in which the amine catalyst is a tertiary amine catalyst, from the perspective of adjusting the curing rate of the composition to an appropriate range.

Examples of the tertiary amine catalyst include trimethylamine, triethylamine, tripropylamine, tributylamine, triamylamine, trihexylamine, trioctylamine, trilaurylamine, dimethylethylamine, dimethylpropylamine, dimethylbutylamine, dimethylamylamine, dimethylhexylamine, dimethylcyclohexylamine, dimethyloctylamine, dimethyllaurylamine, triallylamine, tetramethylethylenediamine, triethylenediamine, N-methylmorpholine, 4,4′-(oxydi-2,1-ethanediyl)bis-morpholine, N,N-dimethylaminoethylmorpholine, N,N-dimethylbenzylamine, pyridine, picoline, dimethylaminomethylphenol, trisdimethylaminomethylphenol, 1,8-diazabicyclo[5.4.0]undecene-1, 1,4-diazabicyclo[2.2.2]octane, triethanolamine, N,N′-dimethylpiperazine, tetramethyl butanediamine, dimorpholinodiethyl ether, bis(2,2-morpholinoethyl)ether, bis(dimethylaminoethyl)ether, and the like. One type of these can be used alone, or two or more types can be used in combination.

Furthermore, the tertiary amine catalyst is preferably a compound having a dimorpholinodiethyl ether structure from the perspective of exhibiting superior effect of the present technology, excellent curability, and excellent storage stability.

The dimorpholinodiethyl ether structure is a structure having a dimorpholinodiethyl ether as a basic structure.

In the dimorpholinodiethyl ether structure, the hydrogen atom contained in the morpholine ring may be substituted with a substituent. The substituent is not particularly limited. Examples thereof include alkyl groups. Examples of the alkyl group include a methyl group and an ethyl group.

Examples of the amine catalyst having the dimorpholinodiethyl ether structure include compounds represented by Formula (9) below.

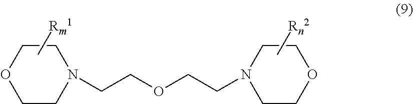

In Formula (9) above, R¹ and R² are each independently an alkyl group, and m and n are each independently 0, 1, or 2.

Specific examples of the amine catalyst having a dimorpholinodiethyl ether structure include dimorpholinodiethyl ether (DMDEE), di(methylmorpholino)diethyl ether, and di(dimethylmorpholino)diethyl ether.

Among these amine catalysts, from the perspectives of achieving excellent coating formability of the adhesive agent (composition of the present technology) during coating and achieving excellent balance between storage stability and curing rate, N,N-dimethylaminoethylmorpholine and compounds having a dimorpholinodiethyl ether structure are preferable, N,N-dimethylaminoethylmorpholine and dimorpholinodiethyl ether are more preferable, and a combination of these is even more preferably used.

As the catalyst having a function that can contribute to adhesion, an organotin catalyst can be used.

Examples of the organotin catalyst include dioctyltin dilaurate, dibutyltin dilaurate, dibutyltin maleate, tin(I) octate, dibutyltin diacetylacetonate, dioctyltin maleate, and the like. One type of these compounds can be used alone, or two or more types can be used in combination.

Other specific examples of the organotin compound described above include a reaction product of 1,3-diacetoxy-1,1,3,3-tetrabutyl-distannoxane and ethyl silicate at a molar ratio of 1:0.8 to 1:1.2 (abbreviated simply as “distannoxane reaction product” in this paragraph hereafter).

The organotin compound is preferably a dibutyltin diacetylacetonate or a distannoxane reaction product and more preferably a distannoxane reaction product, because the compound can improve adhesion to an adherend (coated plate) at low temperatures and also can improve water resistant adhesion.

For example, the distannoxane reaction product can be obtained by mixing 1,3-diacetoxy-1,1,3,3-tetrabutyl-distannoxane and ethyl silicate in a molar ratio in a range of 1:0.8 to 1:1.2 and reacting for 1 to 3 hours at a temperature of 100° C. to 130° C.

The catalyst is preferably a catalyst containing the organotin catalyst and/or the amine catalyst, more preferably a catalyst containing the organotin catalyst and/or the tertiary amine catalyst, and even more preferably a catalyst containing at least one type selected from the group consisting of products formed by reacting 1,3-diacetoxy-1,1,3,3-tetrabutyl-distannoxane with ethyl silicate in a molar ratio of 1:0.8 to 1.2, dibutyltin acetylacetate, dimorpholinodiethyl ether, and diamino ethylmorpholine.

Also from the perspectives of even better adhesion, excellent storage stability of the adhesive agent, and excellent curability of the adhesive agent, as an organotin catalyst, the catalyst containing a product formed by reacting 1,3-diacetoxy-1,1,3,3-tetrabutyl-distannoxane with ethyl silicate in a molar ratio of 1:0.8 to 1.2 and/or dibutyltin acetylacetate, dimorpholinodiethyl ether, and diamino ethylmorpholine is preferable.

The amount of the catalyst is preferably 0.5 parts by mass or less per 100 parts by mass of the urethane prepolymer.

The amount of the organotin catalyst is preferably from 0.0005 to 0.4 parts by mass, more preferably from 0.0005 to 0.3 parts by mass, and even more preferably from 0.005 to 0.05 parts by mass, per 100 parts by mass of the urethane prepolymer from the perspectives of even better adhesion, excellent storage stability, and excellent heat-resistant adhesion.

The amount of the amine catalyst is preferably from 0.004 to 2.2 parts by mass per 100 parts by mass of the urethane prepolymer from the perspectives of even better adhesion, excellent storage stability of the adhesive agent, and excellent curability.

The amount of the dimorpholinodiethyl ether is preferably from 0.002 to 1.2 parts by mass, more preferably from 0.004 to 1.2 parts by mass, and even more preferably from 0.05 to 0.3 parts by mass, per 100 parts by mass of the urethane prepolymer from the perspectives of even better adhesion, excellent curability, and excellent heat-resistant adhesion.

The amount of the diamino ethylmorpholine is preferably 1 part by mass or less, and more preferably from 0.03 to 0.15 parts by mass, per 100 parts by mass of the urethane prepolymer from the perspectives of even better adhesion, excellent adhesion, excellent foaming resistance, and excellent heat-resistant adhesion.

The composition of the present technology may contain, as necessary, additives, such as isocyanate compounds except the aliphatic isocyanate A, silane coupling agents except the aminosilane compound B, adhesion promoters, anti-sagging agents, anti-aging agents, antioxidants, pigments (dyes), thixotropic agents, ultraviolet absorbers, flame retardants, surfactants (including leveling agents), dispersing agents, dehydrating agents, and antistatic agents, in a range that does not inhibit the object of the present technology. The amount of the additive can be adjusted as desired.

Examples of the method for producing the composition of the present technology include the method for producing a one-part moisture-curable urethane composition of the present technology described below.

The composition of the present technology is one-part type.

The composition of the present technology can be cured by water such as moisture. For example, the composition can be cured by moisture in the air under conditions of −20 to +50° C.

Examples of the use of the composition of the present technology include an adhesive agent.

The adherend to which the composition of the present technology can be applied is not particularly limited. Examples thereof include metal (including coated plates), plastic, rubber, and glass.

The composition of the present technology can be applied to the adherend without using a primer on the adherend.

The coated plate is not particularly limited. Examples thereof include conventionally known coated plates. Examples of coating used in the coated plate include acid/epoxy-based coating, acryl/melamine-based coating, and acryl/silicon-based coating.

The method for producing the one-part moisture-curable urethane composition of the present technology will be described below.

The method for producing the one-part moisture-curable urethane composition of the present technology (production method of the present technology) is a method for producing a one-part moisture-curable urethane composition, the method comprising:

a mixing step 1 of obtaining a preliminary composition by mixing a urethane prepolymer, an aliphatic isocyanate A, and an aminosilane compound B; and

a mixing step 2 of producing the one-part moisture-curable urethane composition of the present technology (composition of the present technology) by mixing the preliminary composition and a catalyst.

In the mixing step 1, a preliminary composition is obtained by mixing a urethane prepolymer, an aliphatic isocyanate A, and an aminosilane compound B.

The urethane prepolymer, the aliphatic isocyanate A, and the aminosilane compound B that are used in the mixing step 1 are the same as those described above.

In the mixing step 1, a filler and/or a plasticizer may be further used.

When the filler and/or the plasticizer is further used in the mixing step 1, the preliminary composition may be produced by first mixing the urethane prepolymer, the aliphatic isocyanate A, and the aminosilane compound B, and then adding the filler and/or the plasticizer to the mixture.

Furthermore, the preliminary composition may be produced by mixing the urethane prepolymer, the aliphatic isocyanate A, the aminosilane compound B, and the filler and/or the plasticizer at one time.

Furthermore, for example, the preliminary composition may be produced by mixing the urethane prepolymer, the plasticizer, and the aliphatic isocyanate A, then adding and mixing the aminosilane compound B, and then adding and mixing the filler to the mixture.

In the mixing step 1, for example, a vertical mixer or a horizontal mixer can be used.

The mixing temperature in the mixing step 1 is preferably from 40 to 90° C.

The mixing step 1 is preferably performed under reduced pressure.

Thereafter, in the mixing step 2, the composition of the present technology is produced by mixing the preliminary composition and a catalyst.

The catalyst used in the mixing step 2 is the same as that described above.

In the mixing step 2, for example, a vertical mixer or a horizontal mixer can be used.

The mixing temperature in the mixing step 2 is preferably from 40 to 70° C.

The mixing step 2 is preferably performed under reduced pressure.

When the composition of the present technology further contains an additive, the additive can be appropriately added in the mixing step 1 and/or 2.

### Examples

The present technology will be described below in detail using examples. However, the present technology is not limited to these examples.

### Production of Composition

In the mixing step 1, components shown in the “mixing step 1” row in Table 1 below in compositions (part by mass) shown in Table 1 were used and mixed by a horizontal mixer at 40 to 70° C. for 1 hour to produce a preliminary composition.

Thereafter, in the mixing step 2, components shown in the “mixing step 2” row in Table 1 below in compositions (part by mass) shown in Table 1 were added to the preliminary composition produced as described above, and mixed by a horizontal mixer to produce a composition.

### Evaluation

The following evaluations were performed using the composition produced as described below. The results are shown in Table 1.

### Adhesion to Coated Plates 1 and 2

To coated plates 1 and 2 obtained by respectively applying the coating materials 1 and 2 described below to steel plates, the compositions produced as described above were applied directly without using a primer. Thereafter, the coated plates were left in the condition at 20° C. and 60% relative humidity for 7 days, then immersed in warm water at 40° C. for 7 days, and dried in the condition at 20° C. after the coated plate was removed from the water. The thickness of the cured product of the composition after the composition was left in the condition at 20° C. and 60% relative humidity for 7 days was 3 mm (hereinafter the same).

One end of the cured product of the composition was then held and peeled back by 180 degrees in the condition at 20° C. to observe the failure state. Cases where the cohesive failure was observed on the cured product was evaluated as “CF”, and cases where the interfacial failure was observed on the cured product was evaluated as “AF”.

Coating material 1: Acid/epoxy-based coating material

Coating material 2: Acryl/silicon-based coating material

### Time Required for CF to Occur

Each of the compositions produced as described above was directly applied on the coated plate 2 without using a primer and cured in the condition at 20° C. or 5° C. and 60% relative humidity.

Thereafter, one end of the cured product of the composition was then held and peeled back by 180 degrees in the condition at 20° C. to evaluate the time required for cohesive failure (CF) to occur on the cured product of the composition.

For the test in which the curing was performed in the condition at 20° C., the 180° peel test was performed after 3 days from the start of the curing, and if the failure state at this time was CF, the result was described as “within 3 days”.

The 180° peel test was performed on the fourth day, and if the failure state on the third day was AF but the failure state on the fourth day was CF, the result was described as “4 days”.

The 180° peel test was performed on the tenth day, and if the failure state at this time was AF, the result was described as “10 days or longer”.

For the test in which the curing was performed in the condition at 5° C., the 180° peel test was performed after seven days from the start of the curing, and if the failure state at this time was CF, the result was described as “7 days”.

The 180° peel test was performed on the eighth day, and if the failure state on the seventh day was AF but the failure state on the eighth day was CF, the result was described as “8 days”.

The 180° peel test was performed on the ninth day, and if the failure state on the eighth day was AF but the failure state on the ninth day was CF, the result was described as “9 days”.

The 180° peel test was performed on the tenth day, and if the failure state on the ninth day was AF but the failure state on the tenth day was CF, the result was described as “10 days”.

The 180° peel test was performed on the 15th day, and if the failure state on the tenth day was AF but the failure state on the 15th day was CF, the result was described as “15 days”.

The 180° peel test was performed on the 21st day, and if the failure state at this time was AF, the result was described as “3 W or longer”.

### Curability (Curing Rate)

The tack-free time in the case where each of the compositions produced as described above was cured in the condition at 20° C. and 65% relative humidity was measured.

The composition having a tack-free time of 20 to 120 minutes was evaluated as having excellent curability and written as “0”, and the composition having a tack-free time of longer than 120 minutes was evaluated as having poor curability and written as “×”.

### Storage Stability

Each of the compositions produced as described above was placed in a container, sealed, and stored for 7 days at 50° C. Thereafter, SOD viscosity (Pa·s) was measured, and the rate of the viscosity increase was calculated using the SOD viscosity prior to the storage.

Note that the SOD viscosity was measured using a pressure viscometer (ASTM D 1092) in accordance with JASO (Japanese Automotive Standards Organization) M338-89.

Cases where the rate of the viscosity increase was within 30%, the storage stability was evaluated as being excellent and written as “0”, and the other cases were evaluated and written as “×”.

### Breaking Elongation (Elongation at Break)

A cured product of each of the compositions produced as described above was cut out into a dumbbell-shaped test piece with a thickness of 2 mm (No. 3 dumbbell shape), and the breaking elongation (%) was measured in accordance with JIS (Japanese Industrial Standard) K 6251:2010 at a tensile test speed of 500 mm/min at 23° C.

The breaking elongation is preferably 250% or greater.

TABLE 1

| | | Comparative Examples | | | | | | |
|---|---|---|---|---|---|---|---|---|
| | | 1 | 2 | 3 | 4 | 5 | 6 | 7 |
| Mixing step 1 | Urethane prepolymer 1 | 100 | 100 | 100 | 100 | 100 | 100 | 100 |
| | Aliphatic isocyanate a1 | 4 | | | | | | |
| | (HDI biuret) | | | | | | | |
| | Aliphatic isocyanate a2 | | 4 | | | | | |
| | (TMP/HDI) | | | | | | | |
| | Aliphatic isocyanate a3 | | | | | | | |
| | (HDI allophanate) | | | | | | | |
| | Aliphatic isocyanate a4 | | | | | | | |
| | (HDI nurate) | | | | | | | |
| | Aminosilane compound | | | 3 | | | | |
| | B1 (KBM573) | | | | | | | |
| | Aminosilane compound | | | | 3 | | | |
| | B2 (A-1170) | | | | | | | |
| | Adduct 1 (a1 + B1) | | | | | 5 | | |
| | Adduct 2 (a1 + B2) | | | | | | 3 | 4 |
| | Carbon black | 45 | 45 | 45 | 45 | 45 | 45 | 45 |
| | Plasticizer | 30 | 30 | 30 | 30 | 30 | 30 | 30 |
| | Filler | 25 | 25 | 25 | 25 | 25 | 25 | 25 |
| Mixing step 2 | Organotin catalyst C1 | 0.001 | 0.001 | 0.001 | 0.001 | 0.001 | 0.001 | 0.001 |
| | Organotin catalyst C2 | | | | | | | |
| | Tertiary amine catalyst | 0.01 | 0.01 | 0.01 | 0.01 | 0.01 | 0.01 | 0.01 |
| | D1 | | | | | | | |
| | Tertiary amine catalyst | 0.01 | 0.01 | 0.01 | 0.01 | 0.01 | 0.01 | 0.01 |
| | D2 | | | | | | | |
| Adhesive | Adhesion: coated plate 1 | CF | CF | AF | AF | CF | CF | CF |
| characteristics | at 20° C. (after water | | | | | | | |
| | resistance test at | | | | | | | |
| | 40° C. for 1 week) | | | | | | | |
| | Adhesion: coated plate 2 | AF | AF | CF | CF | CF | CF | CF |
| | at 20° C. (after water | | | | | | | |
| | resistance test at 40° C. | | | | | | | |
| | for 1 week) | | | | | | | |
| | Time required for CF to | Within 3 | Within 3 | 10 days | 10 days | 10 days | 10 days | 10 days |
| | occur when cured at | days | days | or | or | or | or | or |
| | 20° C. on coated plate 2 | | | longer | longer | longer | longer | longer |
| | Time required for CF to | 15 days | 15 days | 3 W or | 3 W or | 3 W or | 3 W or | 3 W or |
| | occur when cured at | | | longer | longer | longer | longer | longer |
| | 5° C. on coated plate 2 | | | | | | | |
| | Curability (curing rate) | ◯ | ◯ | ◯ | ◯ | ◯ | ◯ | ◯ |
| | Storage stability | ◯ | ◯ | ◯ | ◯ | ◯ | X | X |
| | Breaking elongation | 320 | 340 | 400 | 400 | 320 | 380 | 350 |

| | | Working Examples | | | | | |
|---|---|---|---|---|---|---|---|
| | | 1 | 2 | 3 | 4 | 5 | 6 |
| Mixing step 1 | Urethane prepolymer 1 | 100 | 100 | 100 | 100 | 100 | 100 |
| | Aliphatic isocyanate a1 | 1 | 1 | 1 | 4 | 4 | 4 |
| | (HDI biuret) | | | | | | |
| | Aliphatic isocyanate a2 | | | | | | |
| | (TMP/HDI) | | | | | | |
| | Aliphatic isocyanate a3 | | | | | | |
| | (HDI allophanate) | | | | | | |
| | Aliphatic isocyanate a4 | | | | | | |
| | (HDI nurate) | | | | | | |
| | Aminosilane compound | 0.1 | 0.1 | 0.5 | 0.1 | 0.1 | 0.1 |
| | B1 (KBM573) | | | | | | |
| | Aminosilane compound | | | | | | |
| | B2 (A-1170) | | | | | | |
| | Adduct 1 (a1 + B1) | | | | | | |
| | Adduct 2 (a1 + B2) | | | | | | |
| | Carbon black | 45 | 45 | 45 | 45 | 45 | 45 |
| | Plasticizer | 30 | 30 | 30 | 30 | 30 | 30 |
| | Filler | 25 | 25 | 25 | 25 | 25 | 25 |
| Mixing step 2 | Organotin catalyst C1 | 0.001 | 0.001 | 0.02 | 0.01 | 0.3 | 0.4 |
| | Organotin catalyst C2 | | | | | | |
| | Tertiary amine catalyst | 0.01 | 0.01 | 0.02 | 0.002 | 0.01 | 0.01 |
| | D1 | | | | | | |
| | Tertiary amine catalyst | | 0.005 | 0.01 | 0.01 | 0.01 | 0.01 |
| | D2 | | | | | | |
| Adhesive | Adhesion: coated plate 1 | CF | CF | CF | CF | CF | CF |
| characteristics | at 20° C. (after water | | | | | | |
| | resistance test at 40° C. | | | | | | |
| | for 1 week) | | | | | | |
| | Adhesion: coated plate 2 | CF | CF | CF | CF | CF | CF |
| | at 20° C. (after water | | | | | | |
| | resistance test at 40° C. | | | | | | |
| | for 1 week) | | | | | | |
| | Time required for CF to | 4 days | 4 days | 4 days | 4 days | Within 3 | Within 3 |
| | occur when cured at | | | | | days | days |
| | 20° C. on coated plate 2 | | | | | | |
| | Time required for CF to | 10 days | 10 days | 9 days | 10 days | 7 days | 7 days |
| | occur when cured at | | | | | | |
| | 5° C. on coated plate 2 | | | | | | |
| | Curability (curing rate) | ◯ | ◯ | ◯ | X | ◯ | ◯ |
| | Storage stability | ◯ | ◯ | ◯ | ◯ | ◯ | X |
| | Breaking elongation | 350 | 350 | 350 | 310 | 300 | 300 |

| | | Working Examples | | | | | |
|---|---|---|---|---|---|---|---|
| | | 7 | 8 | 9 | 10 | 11 | 12 |
| Mixing step 1 | Urethane prepolymer 1 | 100 | 100 | 100 | 100 | 100 | 100 |
| | Aliphatic isocyanate a1 | 4 | 4 | 4 | 10 | 10 | 10 |
| | (HDI biuret) | | | | | | |
| | Aliphatic isocyanate a2 | | | | | | |
| | (TMP/HDI) | | | | | | |
| | Aliphatic isocyanate a3 | | | | | | |
| | (HDI allophanate) | | | | | | |
| | Aliphatic isocyanate a4 | | | | | | |
| | (HDI nurate) | | | | | | |
| | Aminosilane compound | 1 | 1 | 2 | 0.1 | 3 | 4 |
| | B1 (KBM573) | | | | | | |
| | Aminosilane compound | | | | | | |
| | B2 (A-1170) | | | | | | |
| | Adduct 1 (a1 + B1) | | | | | | |
| | Adduct 2 (a1 + B2) | | | | | | |
| | Carbon black | 45 | 45 | 45 | 45 | 45 | 45 |
| | Plasticizer | 30 | 30 | 30 | 30 | 30 | 30 |
| | Filler | 25 | 25 | 25 | 25 | 25 | 25 |
| Mixing step 2 | Organotin catalyst C1 | 0.001 | | 0.02 | 0.02 | 0.02 | 0.02 |
| | Organotin catalyst C2 | | 0.01 | | | | |
| | Tertiary amine catalyst | 0.01 | 0.01 | 0.02 | 0.02 | 0.02 | 0.02 |
| | D1 | | | | | | |
| | Tertiary amine catalyst | 0.005 | 0.01 | 0.01 | 0.01 | 0.01 | 0.01 |
| | D2 | | | | | | |
| Adhesive | Adhesion: coated plate 1 | CF | CF | CF | CF | CF | CF |
| characteristics | at 20° C. (after water | | | | | | |
| | resistance test at 40° C. | | | | | | |
| | for 1 week) | | | | | | |
| | Adhesion: coated plate 2 | CF | CF | CF | CF | CF | CF |
| | at 20° C. (after water | | | | | | |
| | resistance test at 40° C. | | | | | | |
| | for 1 week) | | | | | | |
| | Time required for CF to | Within 3 | Within 3 | Within 3 | Within 3 | Within 3 | Within 3 |
| | occur when cured at | days | days | days | days | days | days |
| | 20° C. on coated plate 2 | | | | | | |
| | Time required for CF to | 8 days | 8 days | 8 days | 9 days | 8 days | 8 days |
| | occur when cured at | | | | | | |
| | 5° C. on coated plate 2 | | | | | | |
| | Curability (curing rate) | ◯ | ◯ | ◯ | ◯ | ◯ | ◯ |
| | Storage stability | ◯ | ◯ | ◯ | ◯ | ◯ | ◯ |
| | Breaking elongation | 300 | 320 | 320 | 350 | 280 | 270 |

| | | Working Examples | | | | |
|---|---|---|---|---|---|---|
| | | 13 | 14 | 15 | 16 | 17 |
| Mixing step 1 | Urethane prepolymer 1 | 100 | 100 | 100 | 100 | 100 |
| | Aliphatic isocyanate a1 | 10 | 12 | | | |
| | (HDI biuret) | | | | | |
| | Aliphatic isocyanate a2 | | | 4 | | |
| | (TMP/HDI) | | | | | |
| | Aliphatic isocyanate a3 | | | | 4 | |
| | (HDI allophanate) | | | | | |
| | Aliphatic isocyanate a4 | | | | | 4 |
| | (HDI nurate) | | | | | |
| | Aminosilane compound | 4.5 | 3 | 1 | 1 | 1 |
| | B1 (KBM573) | | | | | |
| | Aminosilane compound | | | | | |
| | B2 (A-1170) | | | | | |
| | Adduct 1 (a1 + B1) | | | | | |
| | Adduct 2 (a1 + B2) | | | | | |
| | Carbon black | 45 | 45 | 45 | 45 | 45 |
| | Plasticizer | 30 | 30 | 30 | 30 | 30 |
| | Filler | 25 | 25 | 25 | 25 | 25 |
| Mixing step 2 | Organotin catalyst C1 | 0.001 | 0.001 | 0.01 | 0.01 | 0.01 |
| | Organotin catalyst C2 | | | | | |
| | Tertiary amine catalyst | 0.01 | 0.01 | 0.01 | 0.01 | 0.01 |
| | Dl | | | | | |
| | Tertiary amine catalyst | 0.01 | 0.01 | 0.01 | 0.01 | 0.01 |
| | D2 | | | | | |
| Adhesive | Adhesion: coated plate 1 | CF | CF | CF | CF | CF |
| characteristics | at 20° C. (after water | | | | | |
| | resistance test at 40° C. | | | | | |
| | for 1 week) | | | | | |
| | Adhesion: coated plate 2 | CF | CF | CF | CF | CF |
| | at 20° C. (after water | | | | | |
| | resistance test at 40° C. | | | | | |
| | for 1 week) | | | | | |
| | Time required for CF to | Within 3 | Within 3 | Within 3 | Within 3 | Within 3 |
| | occur when cured at | days | days | days | days | days |
| | 20° C. on coated plate 2 | | | | | |
| | Time required for CF to | 8 days | 8 days | 7 days | 7 days | 7 days |
| | occur when cured at 5° C. | | | | | |
| | on coated plate 2 | | | | | |
| | Curability (curing rate) | ◯ | ◯ | ◯ | ◯ | ◯ |
| | Storage stability | ◯ | ◯ | ◯ | ◯ | ◯ |
| | Breaking elongation | 170 | 150 | 330 | 330 | 330 |

Details of the components listed in Table 1 are as follows.
Urethane prepolymer 1: Urethane prepolymer 1, in which the content of isocyanate group was 1.45%, was synthesized by mixing 500 g of polyoxypropylene diol (average molecular weight: 2000), 1150 g of polyoxypropylene triol (average molecular weight: 5000), and 264 g of 4,4′-diisocyanate phenylmethane (molecular weight: 250) (NCO/OH=1.8 in this case), further adding 800 g of diisononyl phthalate, and stirring in a nitrogen gas stream at 80° C. for 24 hours to allow reaction to proceed.

Note that, in Table 1, 100 parts by mass of the urethane prepolymer 1 contains no diisononyl phthalate.
Aliphatic isocyanate a1: Biuret of HDI represented by Formula (7) above (D165N, manufactured by Mitsui Chemicals, Inc.)
Aliphatic isocyanate a2: Adduct of trimethylolpropane and hexamethylene diisocyanate represented by Formula (5) above (TMP/HDI), Duranate P301-75E, manufactured by Asahi Kasei Chemicals Corporation
Aliphatic isocyanate a3: Allophanate of hexamethylene diisocyanate (HDI), Takenate D178N, manufactured by Mitsui Chemicals, Inc.
Aliphatic isocyanate a4: Nurate of hexamethylene diisocyanate (HDI) represented by Formula (8) above, Takenate D170N, manufactured by Mitsui Chemicals, Inc.
Aminosilane compound B1: N-phenyl-3-aminopropyltriethoxysilane, KBM-573, manufactured by Shin-Etsu Chemical Co., Ltd.
Aminosilane compound B2: N,N-bis[(3-trimethoxysilyl)propyl]amine, Dynasylan 1124 (manufactured by Evonik)
Adduct 1: A compound produced by mixing the aliphatic isocyanate a1 and the aminosilane compound B1 described above in amounts that made the molar ratio of NCO:NH=1:1, and reacting for 10 hours at 50° C.
Adduct 2: A compound produced by mixing the aliphatic isocyanate a1 and the aminosilane compound B2 described above in amounts that made the molar ratio of NCO:NH=1:1, and reacting for 10 hours at 50° C.
Carbon black: N220, manufactured by NSCC Carbon Co., Ltd.
Plasticizer: Diisononyl phthalate (DINP, manufactured by J-PLUS Co., Ltd.)
Filler: Heavy calcium carbonate (Super S, manufactured by Maruo Calcium Co., Ltd.)
Organotin catalyst C1: A reaction product formed by reacting 1,3-diacetoxy-1,1,3,3-tetrabutyl-distannoxane and ethyl silicate at a molar ratio of 1:1 at 100 to 130° C.
Organotin catalyst C2: Dibutyltin diacetylacetonate (manufactured by Nihon Kagaku Sangyo Co., Ltd.)
Tertiary amine catalyst D1: Dimorpholinodiethyl ether (manufactured by San-Apro Ltd.)
Tertiary amine catalyst D2: N,N-dimethylaminoethylmorpholine (manufactured by Air Products and Chemicals, Inc.)

As is clear from the results shown in Table 1, Comparative Examples 1 and 2, which contained no aminosilane compound, exhibited low adhesion.

Comparative Examples 3 and 4, which contained no aliphatic isocyanate A, exhibited low adhesion.

Comparative Examples 5 to 7, which contained no aliphatic isocyanate A and no aminosilane compound but instead contained the adduct 1 or the adduct 2, required a long period of time for cohesive failure to occur and exhibited low adhesion.

On the other hand, Working Examples 1 to 17 achieved excellent adhesion.

Furthermore, when Working Examples 1, 2, and 7 and Working Example 14 are compared, Working Examples 1, 2, and 7, in which the amount of the aliphatic isocyanate A was 10 parts by mass or less per 100 parts by mass of the urethane prepolymer, achieved even better breaking elongation than that of Working Example 14.

When Working Examples 10 to 12 and Working Example 13 are compared, Working Examples 10 to 12, in which the amount of the aminosilane compound B was 4 parts by mass or less per 100 parts by mass of the urethane prepolymer, achieved even better breaking elongation than that of Working Example 13.

When Working Example 4 and the other working examples are compared, working examples having a greater amount of the tertiary amine catalyst D1 than that of Working Example 4 achieved even better curability.

When Working Example 5 and Working Example 6 are compared, a smaller amount of the organotin catalyst C1 resulted in even better storage stability.

When Working Examples 15 to 17 and Working Example 7 are compared, Working Examples 15 to 17, in which the aliphatic isocyanate A was in the form of adduct, allophanate, or nurate, required a short period of time for CF to occur at 5° C. (low temperature condition) and achieved even better adhesion than those of Working Example 7, in which the aliphatic isocyanate A was in the form of biuret.

1. A one-part moisture-curable urethane composition including:
a preliminary composition obtained by mixing a urethane prepolymer, an aliphatic isocyanate A, and an aminosilane compound B, and
a catalyst.

2. The one-part moisture-curable urethane composition according to claim 1, wherein the urethane prepolymer is obtained by reacting polypropylene glycol with diphenylmethane diisocyanate.

3. The one-part moisture-curable urethane composition according to claim 1, wherein the aliphatic isocyanate A is at least one type of aliphatic isocyanate-modified product a selected from the group consisting of reaction products of a polyol having tri- or higher functionality and an aliphatic polyisocyanate, allophanates of aliphatic polyisocyanate, nurates of aliphatic polyisocyanate, and biurets of aliphatic polyisocyanate.

4. The one-part moisture-curable urethane composition according to claim 1, wherein the aminosilane compound B contains, in each molecule, an alkoxysilyl group and a nitrogen atom to which an aromatic ring and a hydrogen atom are bonded.

5. The one-part moisture-curable urethane composition according to claim 4, wherein the alkoxysilyl group is a methoxysilyl group or an ethoxysilyl group.

6. The one-part moisture-curable urethane composition according to claim 1, wherein, per 100 parts by weight of the urethane prepolymer,
an amount of the aliphatic isocyanate A is from 0.8 to 10 parts by mass, and
an amount of the aminosilane compound B is from 0.1 to 4 parts by mass.

7. The one-part moisture-curable urethane composition according to claim 1, wherein the catalyst contains at least one type selected from the group consisting of products formed by reacting 1,3-diacetoxy-1,1,3,3-tetrabutyl-distannoxane with ethyl silicate in a molar ratio of 1:0.8 to 1.2, dibutyltin acetylacetate, dimorpholinodiethyl ether, and diamino ethylmorpholine.

8. The one-part moisture-curable urethane composition according to claim 1, wherein the catalyst contains, as an organotin catalyst, at least one selected from the group consisting of products formed by reacting 1,3-diacetoxy-1,1,3,3-tetrabutyl-distannoxane with ethyl silicate in a molar ratio of 1:0.8 to 1.2 and dibutyltin acetylacetate,
dimorpholinodiethyl ether, and
diamino ethylmorpholine.

9. The one-part moisture-curable urethane composition according to claim 8, wherein an amount of the organotin catalyst is from 0.0005 to 0.3 parts by mass per 100 parts by mass of the urethane prepolymer.

10. The one-part moisture-curable urethane composition according to claim 8, wherein an amount of the dimorpholinodiethyl ether is from 0.004 to 1.2 parts by mass per 100 parts by mass of the urethane prepolymer.

11. The one-part moisture-curable urethane composition according to claim 8, wherein an amount of the diamino ethylmorpholine is 1 part by mass or less per 100 parts by mass of the urethane prepolymer.

12. The one-part moisture-curable urethane composition according to claim 1, wherein the preliminary composition further contains a filler.

13. The one-part moisture-curable urethane composition according to claim 12, wherein the filler is at least one selected from the group consisting of carbon blacks and white fillers.

14. The one-part moisture-curable urethane composition according to claim 1, wherein the preliminary composition further contains a plasticizer.

15. A method for producing a one-part moisture-curable urethane composition, the method comprising:
a mixing step 1 of obtaining a preliminary composition by mixing a urethane prepolymer, an aliphatic isocyanate A, and an aminosilane compound B; and
a mixing step 2 of producing the one-part moisture-curable urethane composition described in claim 1 by mixing the preliminary composition and a catalyst.

16. The method for producing a one-part moisture-curable urethane composition according to claim 15, wherein at least one selected from the group consisting of fillers and plasticizers is further used in the mixing step 1.
